(19) United States
(12) Patent Application Publication
(10) Pub. No.: US 2022/0230630 A1
(43) Pub. Date: Jul. 21, 2022

(54) MODEL LEARNING APPARATUS, METHOD AND PROGRAM

(71) Applicant: NIPPON TELEGRAPH AND TELEPHONE CORPORATION, Tokyo (JP)

(72) Inventors: Takafumi MORIYA, Tokyo (JP); Yusuke SHINOHARA, Tokyo (JP); Yoshikazu YAMAGUCHI, Tokyo (JP)

(73) Assignee: NIPPON TELEGRAPH AND TELEPHONE CORPORATION, Tokyo (JP)

(21) Appl. No.: 17/617,556

(22) PCT Filed: Jun. 10, 2019
(86) PCT No.: PCT/JP2019/022953

§ 371 Date: Dec. 8, 2021

(51) Int. Cl. G10L 15/16; G10L 15/02; G10L 15/06

(52) U.S. Cl. CPC G10L 15/16; G10L 2015/025; G10L 15/063; G10L 15/02

(57) ABSTRACT

A model training device includes: a feature amount extraction unit 2 configured to extract a feature amount that corresponds to each of segments into which a first information sequence is divided by a predetermined unit; a second model calculation unit 3 configured to calculate an output probability distribution of second information when the extracted feature amounts are input to a second model; and a model update unit 4 configured to perform at least one of update of the first model based on the output probability distribution of first information calculated by the first model calculation unit and a correct unit number that corresponds to the acoustic feature amounts, and update of the second model based on the output probability distribution of second information calculated by the second model calculation unit and a correct unit number that corresponds to the first information sequence.

### TECHNICAL FIELD

The present invention relates to a technique for training a model used to recognize speech, images, and the like.

### BACKGROUND ART

In recent speech recognition systems using a neural network, it is possible to directly output a word series based on a feature amount of speech. A model training device of such a speech recognition system that directly outputs a word series based on a feature amount of speech (see, for example, NPLs 1 to 3) will be described with reference to FIG. 1. This training method is described, for example, in the section “Neural Speech Recognizer” of NPL 1.

A model training device shown in FIG. 1 includes an intermediate feature amount calculation unit 101, an output probability distribution calculation unit 102, and a model update unit 103.

A pair of a feature amount, which is a vector of a real number extracted in advance from each sample of training data, and a correct unit number that corresponds to the feature amount, and an appropriate initial model are prepared. As the initial model, a neural network model in which random numbers are assigned to parameters, a neural network model that has already trained using another piece of training data, or the like can be used.

The intermediate feature amount calculation unit 101 calculates, based on an input feature amount, an intermediate feature amount for making it easy for the output probability distribution calculation unit 102 to identify a correct unit. The intermediate feature amount is defined by Expression (1) in NPL 1. The calculated intermediate feature amount is output to the output probability distribution calculation unit 102.

More specifically, assuming that a neural network model is constituted by one input layer, a plurality of intermediate layers, and one output layer, the intermediate feature amount calculation unit 101 calculates an intermediate feature amount for each of the input layer and the plurality of intermediate layers. The intermediate feature amount calculation unit 101 outputs the intermediate feature amount calculated for the last intermediate layer, out of the plurality of intermediate layers, to the output probability distribution calculation unit 102.

The output probability distribution calculation unit 102 inputs the intermediate feature amount ultimately calculated by the intermediate feature amount calculation unit 101 to the output layer of the current model, and thereby calculates an output probability distribution in which probabilities corresponding to units of the output layer are listed. The output probability distribution is defined by Expression (2) in NPL 1. The calculated output probability distribution is output to the model update unit 103.

The model update unit 103 calculates the value of a loss function based on the correct unit number and the output probability distribution, and updates the model so that the value of the loss function is reduced. The loss function is defined by Expression (3) of NPL 1. The update of the model by the model update unit 103 is performed in accordance with Expression (4) in NPL 1.

The above-described processing of extracting intermediate feature amounts, calculating an output probability distribution, and updating the model is repeatedly performed on each pair of feature amounts of the training data and a correct unit number, and the model at a point in time when the repetition of a predetermined number of times is completed is used as a trained model. The predetermined number of times is typically from several tens of millions to several hundreds of millions.

### CITATION LIST

### Non Patent Literature

[NPL 1] Geoffrey Hinton, Li Deng, Dong Yu, George E. Dahl, Abdel-rahman Mohamed, Navdeep Jaitly, Andrew Senior, Vincent Vanhoucke, Patric Nguyen, Tara N. Sainath and Brian Kingsbury, “Deep Neural Networks for Acoustic Modeling in Speech Recognition” IEEE Signal Processing Magazine, Vol. 29, No. 6, pp. 82-97, 2012.

[NPL 2] H. Soltau, H. Liao, and H. Sak, “Neural Speech Recognizer: Acoustic-to-Word LSTM Model for Large Vocabulary Speech Recognition”, INTERSPEECH, pp. 3707-3711, 2017

[NPL 3] S. Ueno, T. Moriya, M. Mimura, S. Sakai, Y. Shinohara, Y. Yamaguchi, Y. Aono, and T. Kawahara, “Encoder Transfer for Attention-based Acoustic-to-word Speech Recognition”, INTERSPEECH, pp 2424-2 428, 2018

### SUMMARY OF THE INVENTION

### Technical Problem

However, if there is no speech of words to be newly learned and only the text of the words can be acquired, learning of the words with the above-described model training device is impossible. This is because training of a speech recognition model that directly outputs words based on the above-described acoustic feature amount requires both speech and the corresponding text.

An object of the present invention is to provide a model training device, a method, and a program that can, even if there is no acoustic feature amount that corresponds to a first information sequence (for example, phonemes or graphemes) to be newly learned, train a model using the first information sequence.

### Means for Solving the Problem

A model training device according to an aspect of the present invention, letting information expressed in a first expression format be first information, information expressed in a second expression format be second information, a model that receives inputs of acoustic feature amounts and outputs an output probability distribution of first information that corresponds to the acoustic feature amounts be a first model, and a model that receives an input of a feature amount corresponding to each of segments into which a first information sequence is divided by a predetermined unit, and outputs an output probability distribution of second information that corresponds to the next segment of each of the segments of the first information sequence be a second model, the model training device comprising: a first model calculation unit configured to calculate an output probability distribution of first information when acoustic feature amounts are input to the first model, and output a piece of first information that has the largest output probability; a feature amount extraction unit configured to extract a feature amount that corresponds to each of segments into which the output first information sequence is divided by a predetermined unit; a second model calculation unit configured to calculate an output probability distribution of second information when the extracted feature amounts are input to the second model; and a model update unit configured to perform at least one of update of the first model based on the output probability distribution of first information calculated by the first model calculation unit and a correct unit number that corresponds to the acoustic feature amounts, and update of the second model based on the output probability distribution of second information calculated by the second model calculation unit and a correct unit number that corresponds to the first information sequence, wherein if there is a first information sequence to be newly learned, the feature amount extraction unit and the second model calculation unit perform processing similar to the processing performed on the output first information sequence, on the first information sequence to be newly learned instead of the output first information sequence, and calculate an output probability distribution of second information that corresponds to the first information sequence to be newly learned, and the model update unit updates the second model based on the output probability distribution of second information sequence that corresponds to the first information sequence to be newly learned and is calculated by the second model calculation unit, and a correct unit number that corresponds to the first information sequence to be newly learned.

### Effects of the Invention

Even if there is no acoustic feature amount that corresponds to a first information sequence to be newly learned, it is possible to train a model using the first information sequence.

### BRIEF DESCRIPTION OF DRAWINGS

FIG. 1 is a diagram illustrating a background art.

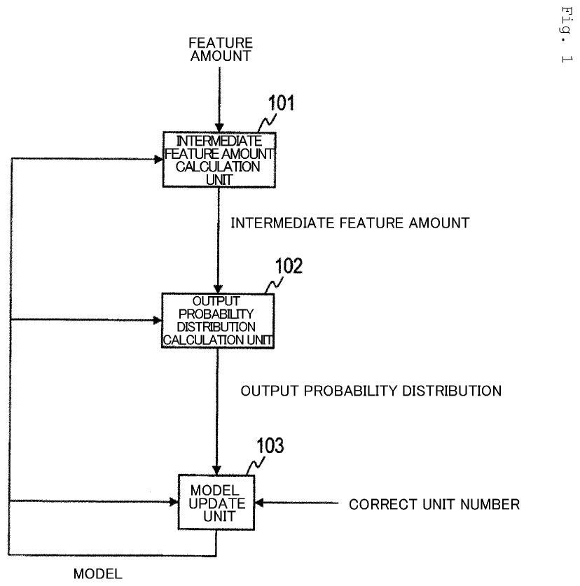

FIG. 2 is a diagram illustrating an example of a functional configuration of a model training device.

FIG. 3 is a diagram illustrating an example of a processing procedure of a model training method.

FIG. 4 is a diagram illustrating an example of a functional configuration of a computer.

### DESCRIPTION OF EMBODIMENTS

Hereinafter, an embodiment of the present invention will be described in detail. Note that the same reference numerals are given to constituent components having the same functions in the drawings, and redundant descriptions are omitted.

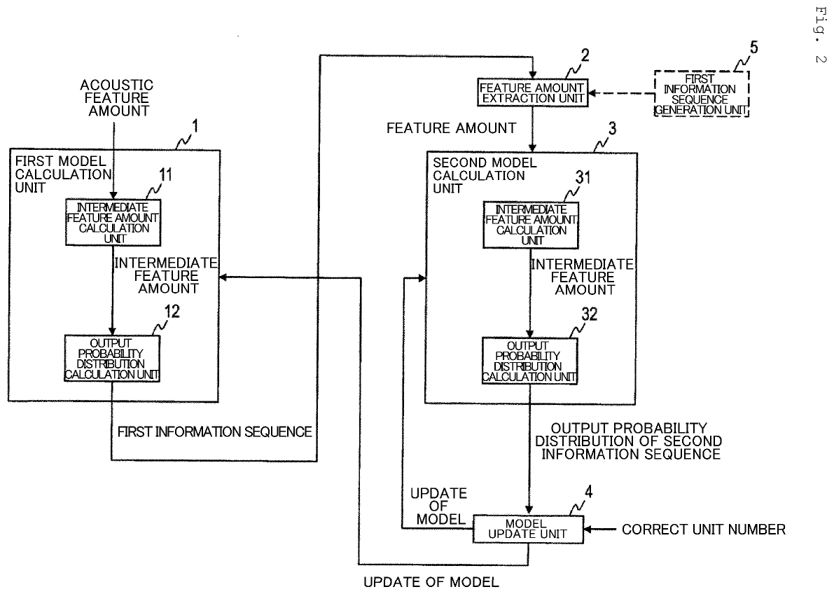

As shown in FIG. 2, in a model training device, a first model calculation unit 1 includes an intermediate feature amount calculation unit 11 and an output probability distribution calculation unit 12, for example.

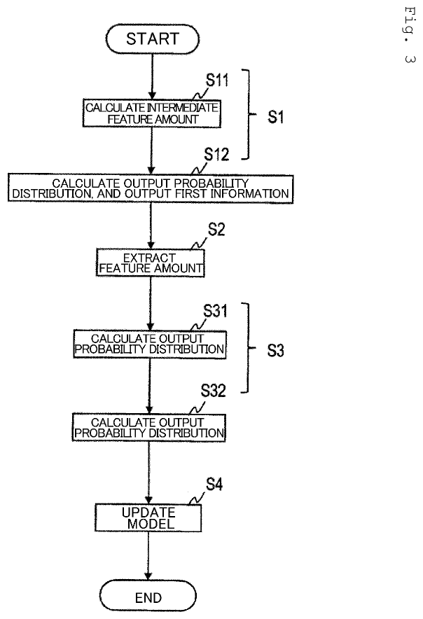

A model training method is realized by, for example, the constituent components of the model training device executing processing from steps S1 to S4 that are described hereinafter and shown in FIG. 3.

The following will describe constituent components of the model training device.

### First Model Calculation Unit 1

The first model calculation unit 1 calculates an output probability distribution of first information when acoustic feature amounts are input to a first model, and outputs the piece of first information that has the largest output probability (step S1).

The first model is a model that receives inputs of acoustic feature amounts and outputs an output probability distribution of first information that correspond to the acoustic feature amounts.

In the following description, information expressed in a first expression format is defined as first information, and information expressed in a second expression format is defined as second information.

Examples of the first information include a phoneme or grapheme. Examples of the second information include a word. Here, a word in English is expressed by alphabet, a numeric character, or a symbol, and a word in Japanese is expressed by Hiragana, Katakana, Kanji, alphabet, a numeric character, or a symbol. The language that corresponds to the first information and the second information may also be any language other than English and Japanese.

The first information may also be musical information such as a MIDI event or a MIDI code. In this case, the second information is, for example, score information.

A first information sequence output by the first model calculation unit 1 is transmitted to a feature amount extraction unit 2.

The first model is a model that receives inputs of acoustic feature amounts, and outputs an output probability distribution of first information that corresponds to the acoustic feature amounts.

In the following, to describe processing performed by the first model calculation unit 1 in detail, the intermediate feature amount calculation unit 11 and the output probability distribution calculation unit 12 of the first model calculation unit 1 will be described.

<<Intermediate Feature Amount Calculation Unit 11>>

Acoustic feature amounts are input to the intermediate feature amount calculation unit 11.

The intermediate feature amount calculation unit 11 generates an intermediate feature amount based on the input acoustic feature amounts and a neural network model, which is an initial model (step S11). The intermediate feature amount is defined by Expression (1) in NPL 1, for example.

For example, an intermediate feature amount yⱼ output from a unit j of an intermediate layer is defined as follows.

$${y}_{j} = \frac{1}{1 + {e}^{- {x}_{j}}} , {x}_{j} - = {b}_{j} + {\sum }_{i = 1}^{J} {y}_{i} {w}_{ij} \qquad [ Math . 1 ]$$

Where J is the number of units, and is a predetermined positive integer. bⱼ is the bias of the unit j. wᵢⱼ is the weight on a connection to the unit j from a unit i of the intermediate layer one level below.

The calculated intermediate feature amount is output to the output probability distribution calculation unit 12.

The intermediate feature amount calculation unit 11 calculates, based on the input acoustic feature amounts and the neural network model, an intermediate feature amount for making it easy for the output probability distribution calculation unit 12 to identify the correct unit. Specifically, assuming that the neural network model is constituted by one input layer, a plurality of intermediate layers, and one output layer, the intermediate feature amount calculation unit 1 calculates an intermediate feature amount for each of the input layer and the plurality of intermediate layers. The intermediate feature amount calculation unit 11 outputs the intermediate feature amount calculated for the last intermediate layer, out of the plurality of intermediate layers, to the output probability distribution calculation unit 12.

<<Output Probability Distribution Calculation Unit 12>>

The intermediate feature amount calculated by the intermediate feature amount calculation unit 11 is input to the output probability distribution calculation unit 12.

By inputting the intermediate feature amount ultimately calculated by the intermediate feature amount calculation unit 11 to the output layer of the neural network model, the output probability distribution calculation unit 12 calculates an output probability distribution in which output probabilities corresponding to the units of the output layer are listed, and outputs the piece of first information having the largest output probability (step S12). The output probability distribution is defined by Expression (2) in NPL 1, for example.

For example, pᵢ output from the unit j of the output layer is defined as follows.

$${P}_{j} = \frac{Exp ( {x}_{j} )}{{\sum }_{j = 1}^{J} exp ( {x}_{j} )} \qquad [ Math . 2 ]$$

The calculated output probability distribution is output to the model update unit 4.

If, for example, the input acoustic feature amount is a speech feature amount, and the neural network model is an acoustic model of a speech recognition neural network type, the output probability distribution calculation unit 12 can calculate a speech output symbol (phoneme state) to which the intermediate feature amount with which the speech feature amount is easily identified corresponds. In other words, an output probability distribution that corresponds to the input speech feature amount can be obtained.

### Feature Amount Extraction Unit 2

The first information sequence output by the first model calculation unit 1 is input to the feature amount extraction unit 2. Also, as described later, if there is a first information sequence to be newly learned, this first information sequence to be newly learned is input thereto.

The feature amount extraction unit 2 extracts a feature amount that corresponds to each of segments into which the input first information sequence is divided by a predetermined unit (step S2). The extracted feature amounts are output to a second model calculation unit 3.

The feature amount extraction unit 2 divides the input first information sequence into segments with reference to a predetermined dictionary, for example.

If the first information is a phoneme or grapheme, the feature amounts extracted by the feature amount extraction unit 2 are language feature amounts.

A segment is expressed by a vector such as a one-hot vector, for example. “One-hot vector” refers to a vector one of whose elements is 1 and all the other are 0.

When, in this manner, a segment is expressed in a vector such as a one-hot vector, the feature amount extraction unit 2 calculates a feature amount by, for example, multiplying the vector corresponding to the segment by a predetermined parameter matrix.

It is assumed that, for example, the first information sequence output by the first model calculation unit 1 is a grapheme sequence expressed in a grapheme “helloiammoriya”. Note that, in this case, the grapheme is alphabet.

The feature amount extraction unit 2 first divides this first information sequence “helloiammoriya” into segments “hello/hello”, “I/i”, “am/am”, and “moriya/moriya”. In this example, each segment is expressed by a grapheme and a word that corresponds to the grapheme. The right side of each diagonal indicates a grapheme, and the left side of the diagonal indicates a word. That is to say, in this example, each segment is expressed in a format “word/grapheme”. This expression format of each segment is an example, and the segment may also be expressed in another format. For example, each segment may also be expressed only by a grapheme as “hello”, “i”, “am”, “moriya”.

If the first information sequence, when divided, includes the words of segments that have the same grapheme but different meanings, or segments that have a plurality of combinations of graphemes, the feature amount extraction unit 2 divides the first information sequence into any one of such segments. For example, if the first information sequence includes a grapheme that corresponds to a multi-sense word, any of segments including the word having a specific meaning is used.

Also, if there are a plurality combinations of graphemes of segments, any of segments is used that are obtained by dividing, for example, a first information sequence “Theseissuedprograms.” into graphemes without taking into consideration grammar. For example, “The/the”, “SE/SE”, “issued/issued”, “programs/programs”, “./.” “The/the”, “SE/SE”, “issued/issued”, “pro/pro”, “grams/grams”, “./.” “The/the”, “SE/SE”, “is/is”, “sued/sued”, “programs/programs”, “./.” “The/the”, “SE/SE”, “is/is”, “sued/sued”, “pro/pro”, “grams/grams”, “./.” “These/these”, “issued/issued”, “programs/programs”, “./.” “These/these”, “issued/issued”, “pro/pro”, “grams/grams”, “./.” “These/these”, “is/is”, “sued/sued”, “programs/programs”, “./.” “These/these”, “is/is”, “sued/sued”, “pro/pro”, “grams/grams”, “./.” Also, a case is assumed in which, for example, the first information sequence output by the first model calculation unit 1 is a syllable sequence expressed in syllables “kyouwayoitenkidesu”.

In this case, the feature amount extraction unit 2 first divides the first information sequence “kyouwayoitenkidesu” into: segments of “kyou(today)/kyou”, “ha/wa”, “yoi(fine)/yoi”, “tenki(weather)/tenki”, “desu/desu”; segments of “kyowa(reprobic)/kyowa”, “yoi(drank)/yoi”, “tenki(crisis)/tenki”, “de(out)/de”, “su(real)/su”; or segments of “kyo(huge)/kyo”, “uwa(Uwa-region)/uwa”, “yo/yo”, “iten(transfer)/iten”, “ki(tree)/ki”, “desu/desu”, for example. In this case, each segment is expressed by a syllable and a word that corresponds to this syllable. The right side of each diagonal indicates a syllable, and the left side of the diagonal indicates a word. That is to say, in this case, each segment is expressed in a “word/syllable” format.

Note that the total number of types of segments is equal to the total number of types of second information for which output probabilities are calculated by a later-described second model. Also, if a segment is expressed by a one-hot vector, the total number of types of segments is equal to the number of dimensions of the one-hot vector for expressing the segment.

### Second Model Calculation Unit 3

The feature amounts extracted by the feature amount extraction unit 2 are input to the second model calculation unit 3.

The second model calculation unit 3 calculates an output probability distribution of second information when the input feature amounts are input to the second model (step S3). The calculated output probability distribution is output to the model update unit 4.

The second model is a model that receives an input of a feature amount corresponding to each of segments into which the first information sequence is divided by a predetermined unit, and outputs an output probability distribution of second information that corresponds to the next segment of each of the segments of the first information sequence.

In the following, to describe processing performed by the second model calculation unit 3 in detail, the intermediate feature amount calculation unit 11 and the output probability distribution calculation unit 12 of the second model calculation unit 3 will be described.

<<Intermediate Feature Amount Calculation Unit 31>>

Acoustic feature amounts are input to the intermediate feature amount calculation unit 31.

The intermediate feature amount calculation unit 31 generates an intermediate feature amount based on the input acoustic feature amounts and the neural network model, which is an initial model (step S11). The intermediate feature amount is defined by Expression (1) in NPL 1, for example.

For example, an intermediate feature amount yⱼ output from a unit j of an intermediate layer is defined as the following Expression (A).

$$[ Math . 3 ]$$

$${y}_{j} = \frac{1}{1 + {e}^{- {x}_{j}}} , {x}_{j} - = {b}_{j} + {\sum }_{i = 1}^{J} {y}_{i} {w}_{ij} \qquad ( 4 )$$

Where J is the number of units, and is a predetermined positive integer. bⱼ is the bias of the unit j. wᵢⱼ is the weight on a connection to the unit j from a unit i of the intermediate layer one level below.

The calculated intermediate feature amount is output to the output probability distribution calculation unit 32.

The intermediate feature amount calculation unit 31 calculates, based on the input acoustic feature amounts and the neural network model, an intermediate feature amount for making it easy for the output probability distribution calculation unit 32 to identify the correct unit. Specifically, assuming that the neural network model is constituted by one input layer, a plurality of intermediate layers, and one output layer, the intermediate feature amount calculation unit 31 calculates an intermediate feature amount for each of the input layer and the plurality of intermediate layers. The intermediate feature amount calculation unit 31 outputs the intermediate feature amount for the last intermediate layer, out of the plurality of intermediate layers, to the output probability distribution calculation unit 32.

<<Output Probability Distribution Calculation Unit 32>>

The intermediate feature amount calculated by the intermediate feature amount calculation unit 31 is input to the output probability distribution calculation unit 32.

By inputting the intermediate feature amount ultimately calculated by the intermediate feature amount calculation unit 31 to the output layer of the neural network model, the output probability distribution calculation unit 32 calculates an output probability distribution in which output probabilities corresponding to the units of the output layer are listed, and outputs the piece of first information having the largest output probability (step S12). The output probability distribution is defined by Expression (2) in NPL 1, for example.

For example, pⱼ output from the unit j of the output layer is defined as follows.

$${P}_{j} = \frac{exp ( {x}_{j} )}{{\sum }_{j = 1}^{J} exp ( {x}_{j} )} \qquad [ Math . 4 ]$$

The calculated output probability distribution is output to the model update unit 4.

### Model Update Unit 4

The output probability distribution of first information calculated by the first model calculation unit 1, and the correct unit number that corresponds to the acoustic feature amounts are input to the model update unit 4. Also, the output probability distribution of second information calculated by the second model calculation unit 3, and the correct unit number that corresponds to the first information sequence are input to the model update unit 4.

The model update unit 4 performs at least one of update of the first model based on the output probability distribution of first information calculated by the first model calculation unit 1, and the correct unit number that corresponds to the acoustic feature amounts, and update of the second model based on the output probability distribution of second information calculated by the second model calculation unit, and the correct unit number that corresponds to the first information sequence (step S4).

The model update unit 4 may perform the update of the first model and the update of the second model at the same time, or may perform the update of one model, and then perform the update of the other model.

The model update unit 4 updates each model using a predetermined loss function calculated based on the corresponding output probability distribution. The loss function is defined by Expression (3) in NPL 1, for example.

For example, a loss function C is defined as follows.

$$C = - {\sum }_{j = 1}^{J} {d}_{j} log {p}_{j}$$

Where, dⱼ denotes correct unit information. For example, when only a unit j′ is correct, dⱼ=1 where j=j′, and dⱼ=0 where j≠j′ are satisfied.

The parameters to be updated are wᵢⱼ and bⱼ of Expression (A).

Assuming that wᵢⱼ after the t-th update is denoted as wᵢⱼ(t), wᵢⱼ after the t+1-th update is denoted as wᵢⱼ(t+1), α₁ is a predetermined number that is greater than 0 and less than 1, and ε₁ is a predetermined positive number (for example, a predetermined positive number close to 0), the model update unit 4 obtains wᵢⱼ(t+1) after the t+1-th update using wᵢⱼ(t) after the t-th update based on, for example, the expression below.

$${w}_{ij} ( i + 1 ) = {α}_{1} {w}_{ij} ( t ) - {ɛ}_{1} \frac{\partial C}{\partial {w}_{ij} ( t )} \qquad [ Math . 6 ]$$

Assuming that bⱼ after the t-th update is denoted as bⱼ(t), bⱼ after the t+1-th update is denoted as bⱼ(t+1), α₂ is a predetermined number that is greater than 0 and less than 1, and ε₂ is a predetermined positive number (for example, a predetermined positive number close to 0), the model update unit 4 obtains bⱼ(t+1) after the t+1-th update using bⱼ(t) after the t-th update based on, for example, the expression below.

$${b}_{j} ( t + 1 ) = {a}_{2} {b}_{j} ( t ) - {ɛ}_{2} \frac{\partial C}{\partial {b}_{j} ( t )} \qquad [ Math . 7 ]$$

Typically, the model update unit 4 repeatedly performs the processing of extracting an intermediate feature amount, calculating output probabilities, and updating the model on each pair of feature amounts serving as training data and a correct unit number, and regards the model at a point in time when the repetition of a predetermined number of times (typically, several tens of millions to several hundreds of millions) is completed.

Note that if there is a first information sequence to be newly learned, the feature amount extraction unit 2 and the second model calculation unit 3 perform processing similar to the above-described processing (steps S2 and S3) on the first information sequence to be newly learned, instead of the first information sequence output by the first model calculation unit 1, and calculates the output probability distribution of second information that corresponds to the first information sequence to be newly learned.

Also, in this case, the model update unit 4 updates the second model based on the output probability distribution of second information sequence that corresponds to the first information sequence to be newly learned and has been calculated by the second model calculation unit 3, and the correct unit number that corresponds to the first information sequence.

With this, according to the present embodiment, even if there is no acoustic feature amount that corresponds to a first information sequence to be newly learned, it is possible to train a model using this first information sequence.

### Experimental Result

For example, it is verified through experiments that by optimizing the first model and the second model at the same time, training of the models having a higher recognition accuracy is possible. For example, when the first model and the second model were optimized separately, the word error rates of predetermined Task 1 and Task 2 were 16.4% and 14.6%, respectively. In contrast, when the first model and the second model were optimized at the same time, the word error rates of the predetermined Task 1 and Task 2 were 15.7% and 13.2%, respectively. Thus, the word error rates for both the Task 1 and Task 2 were lower when the first model and the second model were optimized at the same time than in the other case.

### Modification

The embodiment of the present invention has been described, but the specific configurations are not limited to the embodiment, and possible changes in design and the like are, of course, included in the present invention without departing from the spirit of the present invention.

For example, the model training device may further include a first information sequence generation unit 5 indicated by a dotted line in FIG. 2.

The first information sequence generation unit 5 converts an input information sequence into a first information sequence. The first information sequence converted by the first information sequence generation unit 5 serves as a first information sequence to be newly learned, and is output to the feature amount extraction unit 2.

For example, the first information sequence generation unit 5 converts input text information into a first information sequence, which is a phoneme or grapheme sequence.

The various types of processing described in the embodiment may be not only executed in a time series manner in accordance with the order of description, but also executed in parallel or individually as needed or according to the throughput of the device that performs the corresponding processing.

For example, data communication between the constituent components of the model training device may be performed directly or via a not-shown storage unit.

### Program and Storage Medium

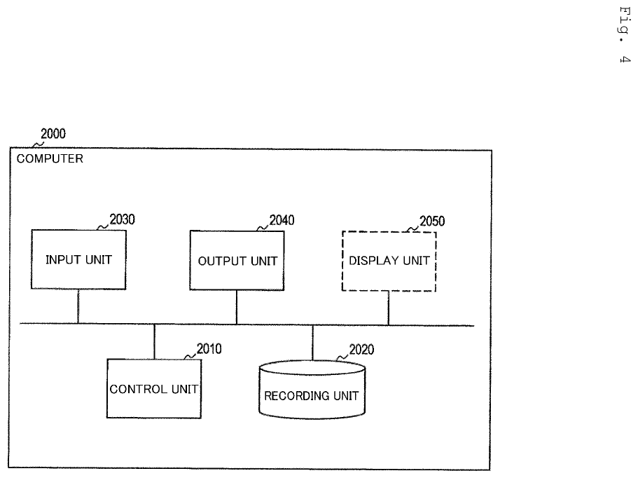

When various types of processing functions of the devices described in the embodiment are implemented by a computer, the processing details of the functions to be assigned to each device are described by a program. When the program is executed by the computer, the various types of processing functions of the devices are implemented on the computer. For example, the above-described various types of processing are executed by the program to be executed being read in a recording unit 2020 of a computer shown in FIG. 4 and a control unit 2010, an input unit 2030, an output unit 2040, and the like operating in accordance therewith.

The program in which the processing details is described can be recorded in a computer-readable recording medium. The computer-readable recording medium can be any type of recording medium such as, for example, a magnetic recording apparatus, an optical disk, a magneto-optical storage medium, or a semiconductor memory.

This program is distributed by, e. g., selling, transferring, or lending a portable recording medium such as a DVD or a CD-ROM in which this program is recorded, for example. Furthermore, this program may also be distributed by storing the program in a storage device of a server computer, and transferring the program from the server computer to another computer via a network.

A computer that executes this type of program first stores the program recorded in the portable recording medium or the program transferred from the server computer in its own storage device, for example. Then, when executing processing, this computer reads the program stored in the own storage device and executes processing in accordance with the read program. Also, as other execution modes of this program, the computer may directly read the program from the portable recording medium and may execute the processing in accordance with this program, or this computer may execute, each time the program is transferred to the computer from the server computer, the processing in accordance with the received program. A configuration is also possible in which the above-described processing is executed by a so-called ASP (Application Service Provider) service, which realizes processing functions only by giving program execution instructions and acquiring the results thereof without transferring the program from the server computer to this computer. Note that it is assumed that the program of this embodiment includes information that is provided for use in processing by an electronic computer and is treated as a program (that is not a direct instruction to the computer but is data or the like having characteristics that specify the processing executed by the computer).

Also, in this embodiment, the device is configured by executing the predetermined programs on the compute, but at least part of the processing details may also be implemented by hardware.

### REFERENCE SIGNS LIST

1 First model calculation unit
11 Intermediate feature amount calculation unit
12 Output probability distribution calculation unit
2 Feature amount extraction unit
3 Second model calculation unit
31 Intermediate feature amount calculation unit
32 Output probability distribution calculation unit
4 Model update unit
5 First information sequence generation unit

1. A model training device, letting information expressed in a first expression format be first information, information expressed in a second expression format be second information, a model that receives inputs of acoustic feature amounts and outputs an output probability distribution of first information that corresponds to the acoustic feature amounts be a first model, and a model that receives an input of a feature amount corresponding to each of segments into which a first information sequence is divided by a predetermined unit, and outputs an output probability distribution of second information that corresponds to the next segment of each of the segments of the first information sequence be a second model, the model training device comprising circuitry configured to execute a method comprising:
calculating an output probability distribution of first information when acoustic feature amounts are input to the first model, and output a piece of first information that has the largest output probability;
extracting a feature amount that corresponds to each of segments into which the output first information sequence is divided by a predetermined unit;
calculating an output probability distribution of second information when the extracted feature amounts are input to the second model; and
performing at least one of update of the first model based on the output probability distribution of first information and a correct unit number that corresponds to the acoustic feature amounts, and update of the second model based on the output probability distribution of second information and a correct unit number that corresponds to the first information sequence,
wherein if there is a first information sequence to be newly learned, performing processing similar to the processing performed on the output first information sequence, on the first information sequence to be newly learned instead of the output first information sequence, and calculating an output probability distribution of second information that corresponds to the first information sequence to be newly learned, and
updating the second model based on the output probability distribution of second information sequence that corresponds to the first information sequence to be newly learned, and a correct unit number that corresponds to the first information sequence to be newly learned.

2. The model training device according to claim 1,
wherein the first information includes a phoneme or grapheme, the predetermined unit includes a syllable or a grapheme, and the second information includes a word.

3. The model training device according to claim 1, the method further comprising,
converting an input information sequence into a first information sequence, and regard the converted first information sequence as the first information sequence to be newly learned.

4. A model training method, letting information expressed in a first expression format be first information, information expressed in a second expression format be second information, a model that receives inputs of acoustic feature amounts and outputs an output probability distribution of first information that corresponds to the acoustic feature amounts be a first model, and a model that receives an input of a feature amount corresponding to each of segments into which a first information sequence is divided by a predetermined unit, and outputs an output probability distribution of second information that corresponds to the next segment of each of the segments of the first information sequence be a second model, the model training method comprising:
calculating an output probability distribution of first information when acoustic feature amounts are input to the first model, and outputting a piece of first information that has the largest output probability;
extracting a feature amount that corresponds to each of segments into which the output first information sequence is divided by a predetermined unit;
calculating an output probability distribution of second information when the extracted feature amounts are input to the second model; and
performing at least one of update of the first model based on the output probability distribution of first information and a correct unit number that corresponds to the acoustic feature amounts, and update of the second model based on the output probability distribution of second information and a correct unit number that corresponds to the first information sequence,
wherein if there is a first information sequence to be newly learned, processing similar to the processing performed on the output first information sequence is performed on the first information sequence to be newly learned instead of the output first information sequence, and an output probability distribution of second information that corresponds to the first information sequence to be newly learned is calculated; and
updating the second model based on the output probability distribution of second information sequence that corresponds to the first information sequence to be newly learned, and a correct unit number that corresponds to the first information sequence to be newly learned.

5. A computer-readable non-transitory recording medium storing computer-executable program instructions that when executed by a processor cause a computer system to execute a model training method,
letting information expressed in a first expression format be first information, information expressed in a second expression format be second information, a model that receives inputs of acoustic feature amounts and outputs an output probability distribution of first information that corresponds to the acoustic feature amounts be a first model, and a model that receives an input of a feature amount corresponding to each of segments into which a first information sequence is divided by a predetermined unit, and outputs an output probability distribution of second information that corresponds to the next segment of each of the segments of the first information sequence be a second model, the model training method comprising:
calculating an output probability distribution of first information when acoustic feature amounts are input to the first model, and outputting a piece of first information that has the largest output probability;
extracting a feature amount that corresponds to each of segments into which the output first information sequence is divided by a predetermined unit;
calculating an output probability distribution of second information when the extracted feature amounts are input to the second model; and
performing at least one of update of the first model based on the output probability distribution of first information and a correct unit number that corresponds to the acoustic feature amounts, and update of the second model based on the output probability distribution of second information and a correct unit number that corresponds to the first information sequence,
wherein if there is a first information sequence to be newly learned, processing similar to the processing performed on the output first information sequence is performed on the first information sequence to be newly learned instead of the output first information sequence, and an output probability distribution of second information that corresponds to the first information sequence to be newly learned is calculated; and
updating the second model based on the output probability distribution of second information sequence that corresponds to the first information sequence to be newly learned, and a correct unit number that corresponds to the first information sequence to be newly learned.

6. The model training device according to claim 1, wherein the first model includes a neural network model representing an acoustic model for speech recognition.

7. The model training device according to claim 1, wherein the second model includes a neural network model predicting a segment of information based on a feature amount of the segment.

8. The model training device according to claim 1, wherein the first information sequence to be newly learned lacks an acoustic feature amount associated with a phoneme or grapheme of the first information sequence to be newly learnt.

9. The model training device according to claim 2, the method further comprising:
converting an input information sequence into a first information sequence, and regard the converted first information sequence as the first information sequence to be newly learned.

10. The model training method according to claim 4,
wherein the first information includes a phoneme or grapheme, the predetermined unit includes a syllable or a grapheme, and the second information includes a word.

11. The model training method according to claim 4, further comprising:
converting an input information sequence into a first information sequence, and regard the converted first information sequence as the first information sequence to be newly learned.

12. The model training method according to claim 4, wherein the first model includes a neural network model representing an acoustic model for speech recognition.

13. The model training method according to claim 4, wherein the second model includes a neural network model predicting a segment of information based on a feature amount of the segment.

14. The model training method according to claim 4, wherein the first information sequence to be newly learned lacks an acoustic feature amount associated with a phoneme or grapheme of the first information sequence to be newly learnt.

15. The computer-readable non-transitory recording medium according to claim 5, wherein the first information includes a phoneme or grapheme, the predetermined unit includes a syllable or a grapheme, and the second information includes a word.

16. The computer-readable non-transitory recording medium according to claim 5, the model training method further comprising:
converting an input information sequence into a first information sequence, and regard the converted first information sequence as the first information sequence to be newly learned.

17. The computer-readable non-transitory recording medium according to claim 5, wherein the first model includes a neural network model representing an acoustic model for speech recognition.

18. The computer-readable non-transitory recording medium according to claim 5, wherein the second model includes a neural network model predicting a segment of information based on a feature amount of the segment.

19. The computer-readable non-transitory recording medium according to claim 5, wherein the first information sequence to be newly learned lacks an acoustic feature amount associated with a phoneme or grapheme of the first information sequence to be newly learnt.

20. The model training method according to claim 10, the method further comprising:
converting an input information sequence into a first information sequence, and regard the converted first information sequence as the first information sequence to be newly learned.
